(19) United States
(12) Patent Application Publication
(10) Pub. No.: US 2023/0158730 A1
(43) Pub. Date: May 25, 2023

(54) VARIABLE COOLING DURING BLOW MOLDING PROCESS

(71) Applicant: ABC TECHNOLOGIES INC., Toronto, Ontario (CA)

(72) Inventors: Farshid SANJABI, Richmond Hill, ON (CA); Avinash JAYAKUMAR, Mississauga, ON (CA); Balwinder SINGH, Brampton, ON (CA)

(21) Appl. No.: 17/918,946

(22) PCT Filed: Apr. 16, 2021
(86) PCT No.: PCT/CA2021/050511

§ 371 Date: Oct. 14, 2022

Related U.S. Application Data
(60) Provisional application No. 63/011,812, filed on Apr. 17, 2020.

(51) Int. Cl. B29C 49/64; B29C 49/78

(52) U.S. Cl. CPC B29C 49/6604; B29C 49/786; B29C 2049/6606; B29C 2049/7868

(57) ABSTRACT

Provided is a method for producing thermoplastic articles. The method comprises forming a hollow parison of heated thermoplastic material and positioning the parison within a cavity of a mold tool, the cavity defining the external configuration of the desired article. Fluid pressure is then applied to an internal chamber defined by the parison upon closure of the mold tool, to expand the parison to conform to the mold cavity. The formed article is then subjected to an in-mold cooling phase to reduce the thermal energy of the formed article sufficiently to permit for safe ejection with reduced distortion. The cooling phase is defined by a variable cooling protocol that applies one or more cycles of thermal shock to the formed article during the in-mold cooling phase.

### FIELD OF THE INVENTION

The present invention relates to the field of blow molding plastic articles, and in particular to a blow molding process that incorporates a variable cooling process.

### BACKGROUND OF THE INVENTION

Hollow articles for use in automotive applications are oftentimes manufactured using a blow molding process. Conventional blow molding is a well-known manufacturing methodology, that generally involves the shaping of a molten thermoplastic polymer parison within a mold tool, using air to urge the parison against a molding surface. Articles of considerable size and geometric complexity may be manufactured using such a process. For instance, blow molding processes are used in the manufacture of automotive running boards, bumpers, and load floors. With sizable articles such as these, the cycle time is typically much longer than other molding processes including injection molding. Cycle times of even longer duration are common if the article requires textures or wordings to be formed on its surface during the blow molding process. In general, to create textures or wordings, the mold is operated at elevated temperatures to facilitate the proper formation of these features on the surface of the article. This elevated temperature may be up to 50° C. higher than a typical blow molding mold temperature, and results in the extended cycle time due to the additional cooling time required for the article to be safely ejected from the mold tool, with minimal part distortion and shrinkage. As articles such as these are often incorporated into larger assemblies, part stability and dimensional consistency are critical for proper fit and finish.

Molding operations are generally defined as having a residence time, that is the period of time the molded article is contained within the mold tool. Once the molding portion of the process is complete, the final stage of this residence time is largely a cooling phase wherein the molded article is subject to conductive cooling via the mold tool. As stated above, the aim of this final stage is to lower the temperature of the molded article to a point where it can be safely ejected. Conventional processes generally use a linear or constant temperature profile, wherein the mold tool is lowered to a temperature that promotes conductive heat loss into the tooling and any coolant fluids flowing therethrough. While this cooling methodology has been successfully employed for many years, improvements in the cooling phase may be beneficial to reducing the overall residence time noted, in particular for sizable articles with complex geometries.

### SUMMARY OF THE INVENTION

According to an aspect of an embodiment, provided is a method for producing thermoplastic articles. The method comprises forming a hollow parison of heated thermoplastic material and positioning the parison within a cavity of a mold tool, the cavity defining the external configuration of the desired article. Fluid pressure is then applied to an internal chamber defined by the parison upon closure of the mold tool, to expand the parison to conform to the mold cavity. The formed article is then subjected to an in-mold cooling phase to reduce the thermal energy of the formed article sufficiently to permit for safe ejection with reduced distortion. The cooling phase is defined by a variable cooling protocol that applies one or more cycles of thermal shock to the formed article during the in-mold cooling phase.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a running board, representing an exemplary article suitable for manufacture in accordance with the disclosed blow molding method that incorporates a variable cooling protocol.

FIGS. 2a to 2e illustrate an exemplary blow molding apparatus suitable for use with the variable cooling protocol.

FIG. 3 illustrates a first embodiment of the variable cooling protocol including a singular heat/cool cycle.

FIG. 4 illustrates a second embodiment of the variable cooling protocol including a plurality of heat/cool cycles.

FIG. 5 details a blow molding process that includes the variable cooling protocol.

FIG. 6 illustrates an exemplary variable cooling protocol based on polypropylene as the selected thermoplastic polymer.

### DESCRIPTION OF PREFERRED EMBODIMENT

Specific embodiments of the present invention will now be described with reference to the figures. The following detailed description is merely exemplary in nature and is not intended to limit the invention or the application and uses of the invention. While a running board is used in the discussion on the workings of the invention, this is merely exemplary. It will be appreciated that other articles of manufacture may benefit from the technology disclosed below. For instance, the enhanced cooling for molded products may be applied to blow molded automotive components including, but not limited to load floors, bumpers, tank/container systems, seating systems, and air induction components. A person skilled in the relevant art will recognize that other configurations and arrangements can be used without departing from the scope of the invention. Furthermore, there is no intention to be bound by any expressed or implied theory presented in the preceding technical field, background, brief summary or the following detailed description.

### Running Board

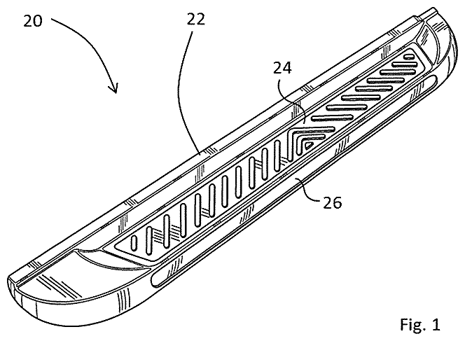

Referring now to FIG. 1, shown is an exemplary running board 20. The running board 20 comprises a main body 22, a step pad 24 and a trim strip 26. The step pad 24 and/or the trim strip 26 may be separately formed elements that are affixed to the main body 22, either as part of an in-mold operation, or during a separate post-mold assembly step in the overall manufacturing process. For the exemplary embodiment used herein, the step pad 24 and the trim strip 26 are integrally molded into the main body 22. It will be appreciated that the integral molding of these features increases the overall geometric complexity of the running board 20, therein increasing the overall complexity of the molding process.

### Exemplary Blow-Molding Apparatus

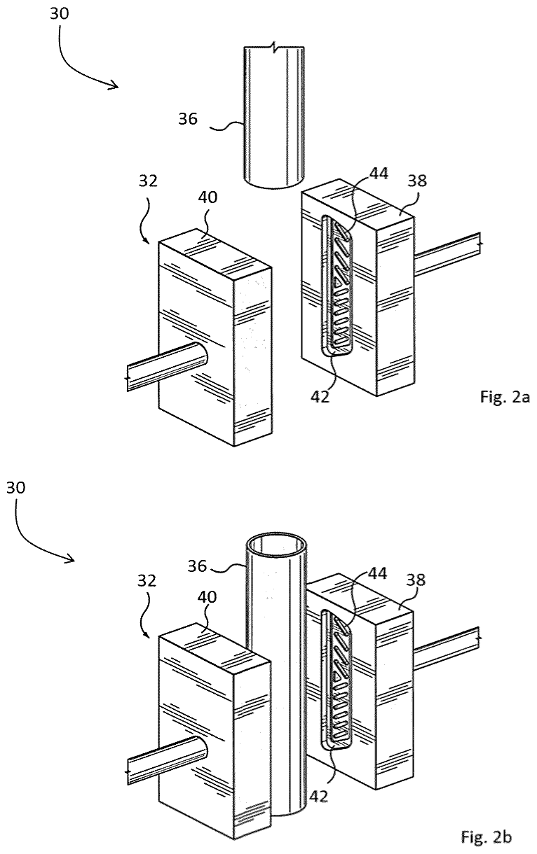

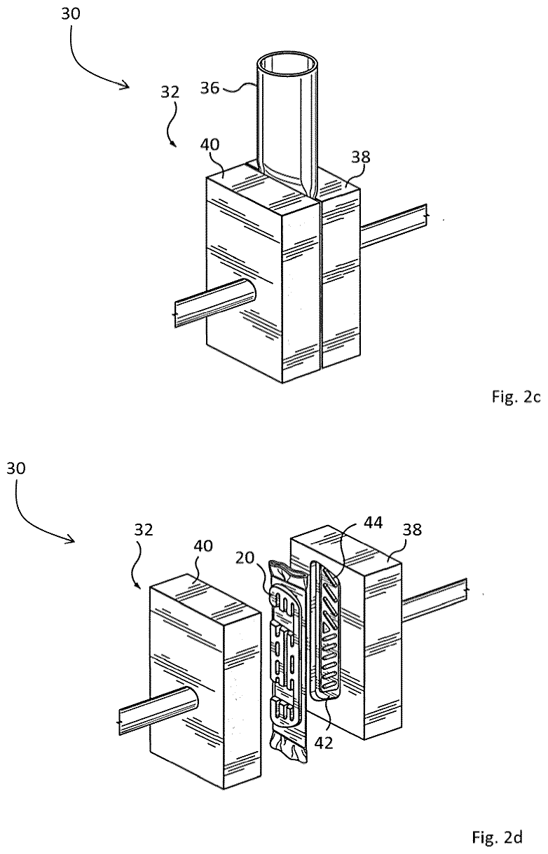

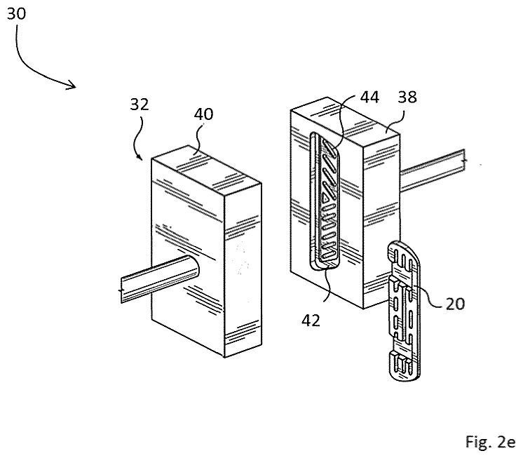

The running board 20 exemplified in FIG. 1 is formed in a blow molding procedure. It will be appreciated by those familiar with the art that a blow molding apparatus suitable for the manufacture of the running board 20 may take on a variety of forms. For simplicity and brevity, an exemplary blow molding apparatus 30 of conventional form is shown in FIGS. 2a through 2e. The blow molding apparatus 30 generally includes a mold tool 32 for forming the running board 20, and an extruder (not shown) for delivering a heated thermoplastic hollow parison 36 to the mold tool 32. The mold tool includes two mold halves, namely a first mold half 38 and a second mold half 40. Each mold half includes a respective portion of a molding surface intended to form the desired article. In the embodiment shown, the first mold half 38 defines a first cavity half 42, while the second mold half 40 defines a second cavity half (not visible in perspective view shown). The first and second mold halves in a closed configuration, that is upon closure of the mold tool 32 collectively define a mold cavity 44 that presents the molding surface for forming the external configuration of the desired article, in this case the running board 20.

On positioning the heated parison 36 within the mold tool 32 (as shown in FIG. 2b), the first and second mold halves are moved to the closed position, as shown in FIG. 2c, thereby pinching the top and bottom ends of the parison 36, to define an internal chamber. At this time, the molding surfaces of the mold cavity 44 are at a predefined elevated temperature selected on the basis of the thermoplastic being molded. The molded formation of the running board 20 is then achieved by subjecting the enclosed structure to blow molding. As such, the parison 36 is caused to bear completely against the molding surface of the cavity 44 provided in the mold tool 32, by way of a fluid pressure medium (e.g. air) introduced through one or more blow needles or pins in fluid communication with the internal chamber formed within the sealed parison 36. The combination of elevated temperature and internal pressure ensures the parison 36 sufficiently contacts and conforms to the molding surface of the mold cavity 44 so as to achieve the desired formation of contours, textures and/or wordings on the molded product.

Once the internal chamber has been sufficiently pressurized to ensure complete contact between the parison 36 and the molding surfaces of the cavity 44, the blow molding apparatus 30 subjects the molded article to a cooling phase, to reduce the overall temperature of the formed article to a point where it can be safely removed from the mold tool 32 with minimal distortion.

On completion of the cooling phase, the mold tool 32 is opened, and the resulting running board 20 is removed, as shown in FIG. 2d. Where necessary, the ejected running board 20 is subjected to post-mold processing to remove flashing or other waste material, as shown in FIG. 2e.

### Enhanced Cooling During Cooling Phase

In a conventional blow-molding operation, the cooling phase may represent a substantial portion of the overall residence time of the molding operation, that is the time the mold tool is closed to form the desired article. The residence time will include both a molding phase in which the parison is fully pressurized against the molding surface of the cavity, and a subsequent cooling phase where the overall thermal energy of the molded article is sufficiently reduced to permit for safe ejection, with minimal part distortion. The overall residence time of a molded article will be dependent upon the article being formed. For instance, for the exemplary running board 20 shown in FIG. 1, a residence time of approximately 180 seconds is generally required. Of this overall cycle time, approximately 60 seconds would be attributed to the molding phase (e.g. parison drop, mold close, mold open and robot in/out, etc.), and approximately 120 seconds would be attributed to the cooling phase. Once again, these values are merely exemplary, as actual values are determined based on numerous factors including, but not limited to article size, geometric complexity, and material composition.

The cooling phase of a conventional blow-molding operation is generally achieved by cooling the mold tool 32 sufficiently down to promote conductive and convective heat loss from the formed thermoplastic article to the surrounding molding environment. For example, in many conventional blow molding operations, it is common practice to reduce the mold temperature to approximately 7° to 10° C. It will be appreciated that mold cooling may be achieved in a number of ways. For example, in some systems, the temperature of the molding environment may be lowered using a suitable cooling medium such as chilled water or liquid nitrogen, the flow of which into/out-of the mold tool is controlled by suitable solenoid valves operable as part of the overall mold tool cooling circuitry. In a conventional process, once the cooling phase begins, the flow of the cooling medium is continuous until the formed article reaches the desired ejection temperature. For instance, for the running board 20 detailed above, the cooling phase is continuous for 120 seconds, after which the mold tool is opened and the formed running board is removed from the mold tool.

To improve upon this conventional cooling process, and given the generally lengthy cooling phase of the overall residence time, the cooling phase is altered to introduce a series of heating/cooling cycles, to introduce a controlled thermal shock into the article being formed. Without wishing to be bound by any particular theory, the introduction of thermal shock through a series of heating/cooling stages during the cooling phase serves to accelerate the process of heat transfer out of the formed article, while maintaining an acceptable part quality. By subjecting the thermoplastic polymer to a min/max temperature range that defines the thermal shock conditions, the polymer is permitted to alternatively form and melt crystals in the polymer structure, which results in giving up greater amounts of thermal energy to the cooled mold tool compared to conventional cooling. The longer the in-mold cooling time the greater the number of variable cooling cycles that can be incorporated into the cooling phase of the residence time. Accordingly, it has been found that through the application of this variable cooling protocol, a number of manufacturing benefits may be realized, including a reduction in residence time leading to a reduction in overall cycle time, increased production, and improvements in part surface quality.

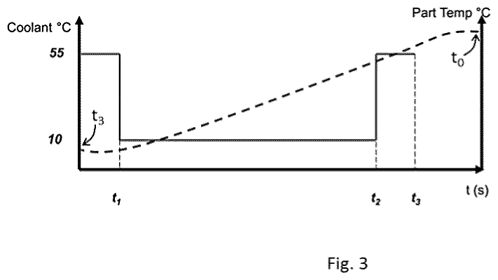

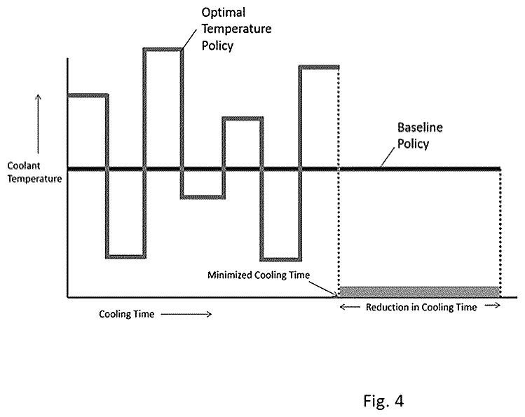

The application of a variable cooling protocol may include a singular heat/cool cycle (see FIG. 3), or it may include a plurality of heat/cool cycles (see FIG. 4), depending on the article being formed, and the available time, that is the length of the cooling phase portion of the residence time. Each cycle will generally present an initial elevated mold temperature, followed by a cooling period, followed by a terminal elevated mold temperature just prior to mold tool opening and molded article ejection. In this way, the initial elevated temperature serves to ensure complete molding of the article based on the features defined by the cavity, the intermediate cooling period serves to remove thermal energy from the molded article, while the final elevated temperature serves to prepare the mold tool for the next molding cycle, while also preventing condensation build-up on the mold surface during cooling, in particular where the mold tool is used in an environment having increased humidity.

### Process Flow

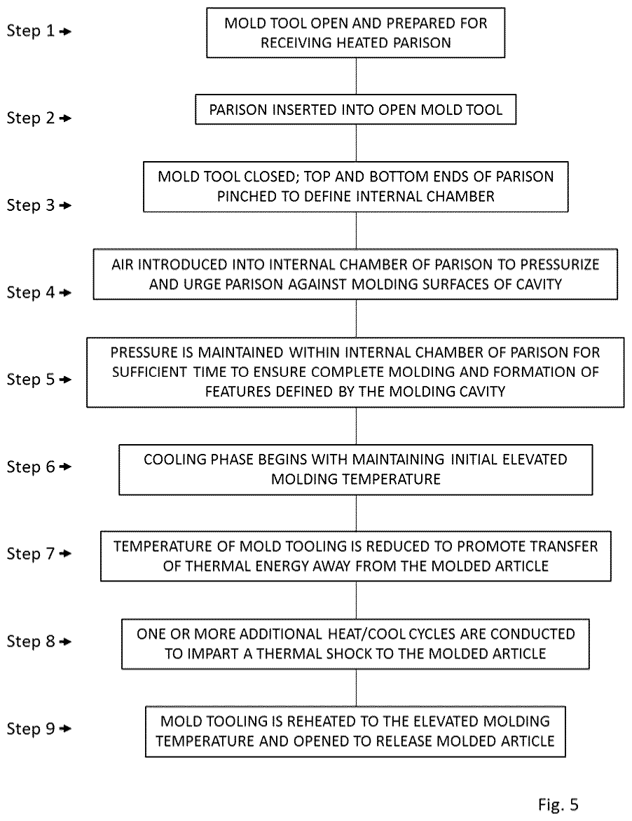

With reference now to FIG. 5, a flow diagram is provided to details the stages of blow molding the running board 20 in accordance with the variable cooling protocol. At Step 1, the mold tool is opened and prepared for receiving the heated parison. At this time, the mold tool is at the desired elevated molding temperature which is generally selected based on the attributes of the thermoplastic being molded. An exemplary set of molding/cooling temperatures is provided later in this discussion. At Step 2, the parison is extruded from the extruder and positioned within the mold tool. Robotic tooling may be implemented to move/locate the parison in the mold tool, depending on the location of the extruder relative to the open mold tool. At Step 3, the mold tool is closed, with the top and bottom ends of the parison being pinched to form the closed internal chamber. At Step 4, the internal chamber of the parison is pressurized using a suitable medium (i.e. air) to urge the parison against the molding surfaced defined by the cavity of the mold tool. At Step 5, the internal pressure within the internal chamber of the parison is maintained for sufficient time to ensure complete molding and formation of the desired features as defined by the molding cavity, including geometry, texture and finer details such as wording/company logos. At Step 6, the cooling phase begins, with the elevated molding temperature being initially maintained. At Step 7, the temperature of the coolant is quickly reduced (i.e. to 7° to 10° C.) to promote the transfer of thermal energy away from the molded article. At step 8, the mold tool undergoes one or more heat/cool cycles to impart a thermal shock upon the molded article. Each heat/cool cycle will include reintroducing heat into the mold tool to a level at or near the molding temperature, and at no point above the thermal degradation temperature of the thermoplastic being used. The subsequent cooling portion of the heat/cool cycle will reintroduce a cooling effect into the mold tool to a level at or above the lower cooling baseline temperature, but lower than the glass transition temperature of the thermoplastic being used. Each heat/cool cycle may introduce a variance to the selected upper and lower temperature limits within this permissible range. Stated differently, each time the mold tool is heated during a thermal shock event, the selected upper temperature need not be the same; similarly, each time the mold tool is cooled during a thermal shock event, the selected lower temperature need not be the same. At Step 9, the mold tool is reheated to the elevated molding temperature and opened to permit for ejection of the formed molded article, in this case the molded running board.

### Exemplary Temperature Profile

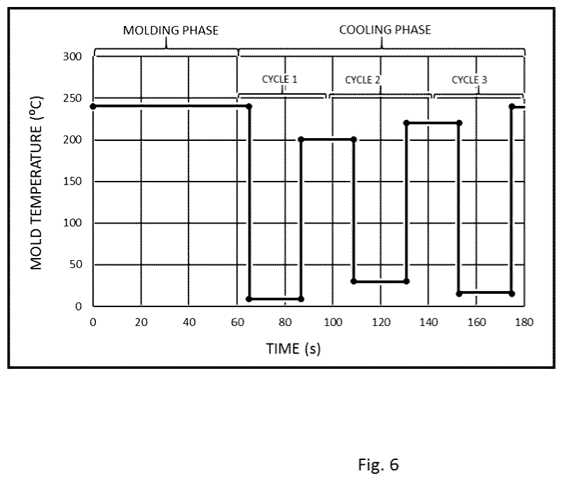

With specific reference now to polypropylene as the thermoplastic used to form the running board 20 shown in FIG. 1, various temperature parameters based on the inherent mechanical properties of the thermoplastic are initially noted to establish the permissible temperature range of the variable cooling protocol. For instance, where a selected polypropylene composition exhibits a thermal degradation temperature of 260° C., an upper elevated molding temperature of 240° C. is established, based on known molding attributes of the polymer. The lower limit of the permissible temperature range is generally established based on the operational parameters of the molding apparatus. For a molding apparatus configured to use water as the cooling medium, the lower limit is generally set to 7° to 10° C. On the basis of this permissible max/min temperature range, reference is made to FIG. 6 which details an exemplary molding cycle that incorporates a variable cooling protocol that includes 3 heat/cool cycles. In this exemplary embodiment, following the 60 seconds molding phase of the residence time, the mold tool enters a 120 second cooling phase. In the first cycle of the cooling phase, the mold temperature is maintained at 240° C. for approximately 5 seconds, after which the mold tool is cooled to a temperature of approximately 8° C. The mold tool is held at this lower temperature for approximately 22 seconds, after which the mold tool is reheated back to 200° C., thus completing the first cycle of the variable cooling protocol. The second and third cooling cycles are similarly structured, with the cooling and heating stages of the second cycle set to 30° C. and 220° C., respectively, and the cooling and heating stages of the third cycle set to 15° C. and 240° C., respectively. As the third cycle represents the end of the variable cooling protocol, the final temperature, that is the heating temperature established at the end of the cycle is the initial molding temperature, in this case 240° C. While the duration of each stage has been exemplified as being equal (i.e. 22 seconds), it will be appreciated that in some embodiments the selected duration may be variable from stage to stage.

### Protocol Profile

The variable cooling protocol described above includes 3 heat/cool cycles, with generally equivalent blocks of time for each of the heating/cooling stages of the process. It will be appreciated that the temperatures selected and the duration of any of the heating/cooling stages may be selected based on observed performance, including the final cooling effect achieved, and the overall time required before final ejection of the molded article. While the parameters of the variable cooling protocol may be manually set, in some embodiments a controller may be suitably implemented. The controller may be configured to read data from the molding environment on the heat/cool conditions to adjust the protocol as necessary. In some embodiments, the variable cooling protocol may implement machine language/artificial intelligence technology to optimize the process, based on selected input parameters. Process optimization may be used to select the high/low temperatures for each heat/cool cycle, the duration of time for each of the temperature shifts, the rate of temperature transition and the number of heat/cool cycles included in the variable cooling protocol.

### MISCELLANEOUS

While the variable cooling protocol has been exemplified having regard to a blow molding process for making a running board, as stated earlier the technology may be successfully applied in the manufacture of other thermoplastic components. In some instances, the thermoplastic components may additionally incorporate reinforcement features including, but not limited to, ribs to provide additional strength and localized reinforcement to prevent warpage and structural failure. It will also be appreciated that polypropylene was selected as an exemplary material for the purpose of discussion and that a variety of other thermoplastics may benefit from the variable cooling protocol, including but not limited to polyethylene, ABS, ABS/PC, polyamide, PLA and PPS. Suitable thermoplastics may additionally include additives to impart desired performance characteristics; additives may include, but are not limited to natural and synthetic fibers, minerals, or a combination thereof.

The blow molding apparatus best suited for the variable cooling protocol described above is one that permits for rapid shifts in the temperature of the molding environment. Various technologies are available to facilitate such temperature transitions, but it is contemplated that any such temperature regulating technology may be suitably implemented. For instance, to achieve adequate and rapid cooling, the cooling circuitry may include the use of baffles, thermal pins, cooling inserts, as well as materials with enhanced thermal conductive properties (i.e. MoldMax Alloys). Cooling channels may be conformal in nature, to ensure close positioning to the molding surface. It will also be preferred that the cooling channels be drainable, or self draining by design so as to be properly vacated prior to the heating stage, therein reducing an undesirable heatsink effect resulting from water/coolant retained in close proximity to the molding surface. Stated differently, it is preferred that the cooling circuitry be arranged so as to reduce the extent of heat loss to the coolant during the heating stages of each cycle of the variable cooling protocol.

Similarly, technologies that permit for rapid heating of the mold tool may also be suitably implemented. For instance, inducting heating technology may be used to achieve the required rapid heating of the mold tool during each cycle of the variable cooling protocol. Conventional heaters may also be suitably implemented with proper placement for optimized temperature distribution. In one particular embodiment, heating elements may be placed approximately 6 mm from the mold tool molding surface to achieve the desired heating characteristics within the desired timeframe (i.e. 2 seconds). As thermoplastic polymers may be susceptible to thermal degradation under extreme heating conditions, it will be appreciated that the placement of heating elements or any alternative means to achieve the required heating effect take into account recommended minimal spacing between the heating element and the molding surface. In the above suggested embodiment where heating elements are placed at approximately 6 mm from the molding surface, care must be taken during mold design to avoid distances smaller than this value, for risk of burning the thermoplastic during the molding operation and subsequent variable cooling protocol.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1. A method for producing thermoplastic articles, the method comprising:
forming a hollow parison of heated thermoplastic material,
positioning the parison within a cavity of a mold tool, the cavity defining the external configuration of the desired article,
applying fluid pressure to an internal chamber defined by the parison upon closure of the mold tool, to expand the parison to conform to the mold cavity,
subjecting the formed article to an in-mold cooling phase to reduce the thermal energy of the formed article sufficiently to permit for safe ejection with reduced distortion,
wherein the in-mold cooling phase is defined by a variable cooling protocol that applies one or more cycles of thermal shock to the formed article during the cooling phase.

2. The method for producing thermoplastic articles according to claim 1, wherein each cycle of the variable cooling protocol includes an initial stage of elevated temperature, followed by an intermediate stage of cooling, followed by a terminal stage of elevated temperature.

3. The method for producing thermoplastic articles according to claim 2, wherein the elevated temperature selected for each cycle is lower than the thermal degradation temperature of the thermoplastic being used.

4. The method for producing thermoplastic articles according to claim 2, wherein the elevated temperature selected for the initial stage and the elevated temperature selected for the terminal stage of any cycle in the variable cooling protocol need not be the same.

5. The method for producing thermoplastic articles according to claim 2, wherein the heating stages and the cooling stages defining the variable cooling protocol are equal in duration.

6. The method for producing thermoplastic articles according to claim 2, wherein the heating stages and the cooling stages defining the variable cooling protocol are unequal in duration.

7. The method for producing thermoplastic articles according to claim 1, wherein the variable cooling protocol includes a terminal stage of elevated temperature prior to opening the mold tool.

8. The method for producing thermoplastic articles according to claim 1, wherein the parameters of the variable cooling protocol are manually set.

9. The method or producing thermoplastic articles according to claim 1, wherein the parameters of the variable cooling protocol are optimized using machine language or artificial intelligence based selected input parameters.
